(19) United States
(12) Patent Application Publication
(10) Pub. No.: US 2026/0046200 A1
(43) Pub. Date: Feb. 12, 2026

(54) BLENDED REMOTE-LOCAL SETTINGS MANAGEMENT ENGINE IN A CLOUD ACCESS MANAGEMENT SYSTEM

(71) Applicant: Microsoft Technology Licensing, LLC, Redmond, WA (US)

(72) Inventors: Christiaan Brinkhoff, Woodinville, WA (US); Christian Cruz Montoya, San Diego, CA (US); Andrew Ho Yin Miyasato, Kirkland, WA (US); Zachary Cole Willson, Redmond, WA (US); Elina Luthra, Seattle, WA (US); Amar Dinesh Zavery, Redmond, WA (US); Killian Quinn Mccoy, Seattle, WA (US); Sandeep Patnaik, Kirkland, WA (US)

(21) Appl. No.: 18/797,378

(22) Filed: Aug. 7, 2024

(51) Int. Cl. H04L 41/0806; H04L 41/22

(52) U.S. Cl. CPC H04L 41/0806; H04L 41/22

(57) ABSTRACT

Methods, systems, and computer storage media for providing blended settings management using a blended remote-local settings management engine are described. The blended remote-local settings management engine integrates different settings controllers into blended settings management via remote clients. In operation, an indication to initiate settings configuration is accessed at a remote client. The indication is processed using a blended remote-local settings management engine that integrates management of remote settings of remote clients and local settings of local clients. Based on the indication, a request for a local setting of a local client associated with the remote client is generated. The request is communicated to the local client using a dynamic virtual channel between the remote client and the local client. Based on the request, the local setting of the local client is retrieved. Display of the local setting is caused on a blended remote-local settings interface associated with blended settings management.

### BACKGROUND

Users rely on computing environments with applications and services to accomplish computing tasks. Distributed computing systems and/or cloud computing platforms host and support different types of applications and services in managed computing environments. In particular, a cloud computing platform can implement a cloud access management system that provides access management functionality for different types of cloud computing offerings. For example, a cloud access management system can provide local clients access to remote clients-including managed desktop services that include virtual machines assigned to individual users as virtual desktop devices configured with productivity, security, and collaboration tools.

### SUMMARY

Various aspects of the technology described herein are generally directed to systems, methods, and computer storage media for, among other things, providing blended settings management using a blended remote-local settings management engine of a cloud access management system. Cloud access management supports access management operations for providing remote client sessions between local clients and remote clients to enable users to seamlessly access cloud-based resources. The blended remote-local settings management engine operates using a shared extension-based framework (e.g., custom settings handlers, custom settings view models, extension services, and a unified Application Programming Interface—API) for integrating different settings controllers into blended settings management via remote clients. The blended remote-local settings management engine provides blended settings management experiences on remote clients that mirror local settings management of local clients. In this way, users can retain control over local settings of their local clients when utilizing remote clients (e.g., in boot-to-cloud scenarios)—enabling them to seamlessly configure different types of local hardware and software settings (e.g., display settings, audio settings).

Conventionally, cloud access management systems are not configured with a comprehensive computing and logic and infrastructure to adequately manage local settings of local client using cloud-based resources (e.g., remote client). The inability of remote clients to manage local settings on the local clients stems from early design priorities that emphasized security, stability, and isolation over local integration. Remote clients operate in a virtualized environment that is separate from the local client, with virtualization technology that restricts interaction with local settings. Many remote client solutions are designed for a consistent remote experience rather than deep integration with local hardware or software, often excluding local settings configuration. Additionally, the complexity of synchronizing local settings with a remote environment can affect performance and stability, further limiting the implementation and development of this functionality. These factors highlight the challenges in achieving seamless local settings adjustments within a remote client framework.

Historically, addressing the limitations of remote clients in this context involved one-off or piecemeal solutions rather than comprehensive, integrated systems. Custom scripts and third-party tools were often used for specific tasks like display configurations or peripheral management, but these were not seamlessly integrated into the remote client environment. Peripherals frequently needed pre-configuration on the local client before connecting to the remote client, as they could not be dynamically adjusted once connected, leading to potential productivity issues and manual adjustments. Vendor-specific workarounds, such as specialized drivers, and manual adjustments for settings like multi-monitor setups lacked broader integration. IT departments also used remote support tools to address local settings issues, and some organizations developed ad-hoc solutions, which were not standardized or unified in managing local and remote settings.

A technical solution—to the limitations of conventional cloud access management systems—can include providing blended settings management resources via a blended remote-local settings management engine that enables simulating local settings configuration interfaces of local clients via remote settings configuration interfaces on remote clients. Blended settings management can be performed via a dynamic virtual channel between a remote client and a local client, where the dynamic virtual channel supports communication of blended remote-local settings management data between the local client and the remote client. The blended remote-local settings management engine provides a solution for managing both remote settings and local settings via a unified blended remote-local settings interface that simplifies administration by allowing control over local hardware and software settings from a remote client, thus reducing the need for separate tools. This integration improves user experience by enabling seamless management of local settings associated with physical devices and peripherals and software environments and applications of a local client.

The blended remote-local settings management engine also enhances operational efficiency by streamlining local settings configuration via remote clients. The blended remote-local settings management engine operates based on a shared extension-based framework that is backwards compatible, such that, newer versions of operating systems on remote clients can operate with older versions of operations systems of local clients. And, the shared extension-based framework is also cross-platform compatible, such that, the functionality can be provided on multiple operating systems or devices without modification. In this way, the blended remote-local settings management engine provides a fully integrated solution that combines remote and local settings management offers a unified approach to configuration, enhances user experience, increases efficiency, ensures consistency and versatility across different versions and environments.

In operation, in a first embodiment, an indication to initiate settings configuration is accessed at a remote client. The indication is processed using a blended remote-local settings management engine that integrates management of remote settings of remote clients and local settings of local clients. Based on the indication, a request for a local setting of a local client associated with the remote client is generated. The request is communicated to the local client using a dynamic virtual channel between the remote client and the local client. The dynamic virtual client channel supports communication of blended remote-local settings management data between the local client and the remote client. Based on communicating the request, the local setting of the local client is retrieved. Display of the local setting is caused on a blended remote-local settings interface.

In a second embodiment, a request from a remote client for a local setting of the local client is accessed the local client. The request is accessed via a dynamic virtual channel between the remote client and the local client. Using a blended remote-local settings management engine client on the local client, the local setting is retrieved. The blended remote-local settings management engine is integrated with a plurality of setting controllers to—on the local client—to support executing requests from remote clients for local client settings of local clients. The local setting is communicated to the local client. The local setting is communicated via the dynamic virtual channel.

In a third embodiment, display of a local setting and one or more selectable alternative local settings is caused on a blended remote-local settings interface. The local setting is associated with a local client. A selected alternative local setting from the one or more selectable alternative local settings is received. An indication to configure the local client based on the selected alternative local setting is communicated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram of an exemplary cloud access management system including a blended remote-local settings management engine, in accordance with aspects of the technology described herein;

FIG. 2 is a block diagram of an exemplary cloud access management system including a blended remote-local settings management engine, in accordance with aspects of the technology described herein;

FIG. 3 provides a first exemplary method of providing blended settings management using a blended remote-local settings management engine, in accordance with aspects of the technology described herein;

FIG. 4 provides a second exemplary method of providing blended settings management using a blended remote-local settings management engine, in accordance with aspects of the technology described herein;

FIG. 5 provides a third exemplary method of providing blended settings management using a blended remote-local settings management engine, in accordance with aspects of the technology described herein;

FIG. 6 provides a block diagram of an exemplary cloud access management system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

A cloud access management system provides access management functionality for different types of cloud computing offerings. The cloud access management system can be a centralized platform designed to facilitate secure and efficient access to cloud-based resources from various devices, including traditional desktops, laptops, and thin clients. The cloud access management system can include software, hardware, and infrastructure components that enable users to authenticate, connect, and interact with remote resources hosted in the cloud. The cloud access management system manages operations associated with user identities, permissions, and access policies to ensure that only authorized users can access specific resources. Additionally, it may incorporate features such as single sign-on (SSO), multi-factor authentication (MFA), and session management to enhance security and user experience.

Conventionally, cloud access management systems are not configured with a comprehensive computing and logic and infrastructure to adequately manage local settings of local devices using cloud-based resources (e.g., remote client). Remote clients often have limitations in seamlessly configuring local settings on local clients that are used to access them. For example, when a user accesses a remote client from a local client, the user cannot directly adjust display settings for the monitor physically connected to the local client through the remote client's operating system interface. This lack of integration means that certain local configuration tasks, like adjusting screen resolution or other hardware settings, must be managed separately from the remote client environment.

The inability of remote clients to seamlessly manage local settings on the local client from which they are accessed can be associated inherent early designs of remote clients that prioritized security, stability, and isolation over integration with local client. Remote clients operated within a virtualized environment that remained distinctly separate from the local client, where the virtualization technology limited the ability to interact with or modify the local settings of the local client. Many remote client solutions are also optimized to deliver a consistent remote client experience rather than facilitating deep integration with local hardware or software. As a result, features for configuring local settings are often excluded from their capabilities. Finally, the complexity involved in managing and synchronizing local settings from a remote client environment can impact both performance and stability, leading to practical limitations in enabling such functionalities. These combined factors underscore the challenge of achieving seamless local settings adjustments within a remote client framework.

Historically, solutions to the limitations of remote clients have often been implemented as one-off or piecemeal approaches rather than through comprehensive, fully integrated systems. For example, custom scripts and third-party tools were developed to handle specific tasks such as advanced display configurations or peripheral device management, but these were not seamlessly integrated into the remote client environment. Moreover, in some scenarios, peripherals had to be preconfigured on the local client before connecting to the remote client. This pre-configuration was necessary because, once connected, these peripherals could not be dynamically configured through the remote client. If the initial setup was not completed beforehand, users would face limitations in managing or adjusting the peripheral settings remotely, which could hinder productivity and require additional manual interventions.

Vendor-specific workarounds provided by hardware or software manufacturers, such as specialized drivers, addressed particular issues but lacked broader system integration. Users often had to manually adjust local settings, like multi-monitor setups, directly on their local client, bypassing the remote client controls. IT departments sometimes resorted to remote support sessions to configure local settings, using remote tools to address settings issues rather than incorporating these capabilities into the remote client system. Additionally, some organizations developed ad-hoc integration solutions for specific needs, but these were typically implemented on a case-by-case basis and did not offer a unified or standardized approach to managing both local and remote settings. As such, a comprehensive cloud access management system—with an alternative basis for performing settings management operations—can improve computing operations and interfaces in cloud access management systems.

### Description of Technical Solution

At a high level, a blended remote-local settings management engine enables simulating local settings configuration interfaces of local clients via remote settings configuration interfaces on remote clients. The blended remote-local settings management engine is an integrated settings management framework that is designed to handle and manage configuration of remote settings of remote client and local setting of local client in a blended and integrated manner. The blended remote-local settings management engine provides a bridge between remote settings and local settings via an endpoint on the local client. The blended remote-local settings management engine can provide pass-through settings data configuration where data is transmitted from local clients or remote clients for blended settings management using remote client resources.

The blended remote-local settings management engine employs a bridge that facilitates communication between different virtual channels by routing data seamlessly across them. The bridge enables interoperability and data exchange between disparate remote clients and local clients by linking their virtual communication paths, ensuring efficient and transparent data flow. A dynamic virtual channel refers to a logical connection established between a remote client and a local client to support blended remote-local settings management. The dynamic virtual channel can provide a dedicated path or channel for transmitting blended remote-local settings management data between a remote client and a local client. The dynamic nature of the channel indicates that the establishment or allocation of the virtual channel does not have to be fixed or preconfigured. The dynamic virtual channel can be created and managed dynamically based on real-time needs and conditions of the blended remote-local settings management. The dynamic virtual channel can operate based on a bridge that is defined on the remote client to support pass-through settings data configuration. The dynamic virtual channel is initialized to support redirecting configuration of a plurality of settings—associated with setting controllers on a local client—to a remote client.

Settings (e.g., hardware settings and software settings) of the local client are accessible and configurable on a remote client via the local endpoint. The remote client employs blended remote-local settings interfaces that integrate and display blended remote-local settings management data from local clients into remote client user interfaces-providing a unified and intuitive configuration experience. Users can easily connect to a remote client, view and modify a local setting of a local client, and receive real-time feedback, all within a cohesive and recognizable framework that minimizes confusion and enhances usability.

The blended remote-local settings management engine allows configuration of settings that do not exist on a remote client. The blended remote-local settings management engine determines that a requested setting (e.g., display setting) does not exist on the remote client. However, based on the setting existing on the local client associated with the remote client, the blended remote-local settings management engine retrieves the local setting and causes display of the local setting, and facilitates configuration of the local setting.

The blended remote-local settings management engine can modify (e.g., set, update, or configure) a local setting from the remote client based on a user selecting an alternative local setting for configuring the setting on the local client. The blended remote-local settings management engine leverages existing components in the remote client and integrates the blended remote-local setting management data into the remote client using these existing components. In this way, the blended remote-local settings management engine operates based on transmitting raw local settings data (i.e., the blended remote-local setting management data) directly from local clients to remote clients-focusing on simple data transfer with minimal processing. This approach is straightforward and efficient and can involve sending specific pieces of information (e.g., local settings and alterative local settings) directly to the remote client without altering their format or meaning.

The blended remote-local settings management engine is implemented based on a shared extension-based framework (e.g., custom settings handlers, custom settings view models, extension service, and a unified Application Programming Interface—API) for integrating different settings controllers into blended settings management via remote clients. The blended remote-local settings management engine facilitates integrating different types of setting controllers for blended settings management. The blended remote-local settings management engine provides a bridge via a local endpoint on the local client to a plurality of settings controllers on the local client. A settings controller can refer to a module within a client that is responsible for managing and controlling settings. The settings controller typically provides functionalities to handle the storage, retrieval, manipulation, and application of configuration settings that affect the behavior or appearance of the software application. The local settings controller can be associated with a software interface that allows users to modify and manage both hardware and software settings on their local computer. Settings controllers can each provide an organized and intuitive GUI for adjusting system configurations corresponding to display resolution, Bluetooth device management, and privacy permissions, streamlining access to critical settings. A settings controller facilitates seamless customization and optimization of the computing environment, ensuring efficient performance and user-specific configurations.

The blended remote-local settings management engine can include APIs and extension services that provide a centralized mechanism for processing and responding to events triggered by requests, enhancing consistency and modularity. The blended remote-local settings management engine can operate as a middleware component that intercepts incoming requests and passes them to the appropriate endpoint handler. The requests can further be used to retrieve data that is managed and displayed using view models of the shared extension-based framework.

The shared extension-based framework facilitates normalizing actions to standardize and harmonize the operations or requests that the blended remote-local management engine can handle, ensuring consistent behavior and responses across different types of setting controllers (e.g., display resolution, keyboard layout, power settings, audio volume, USB device settings, and storage device configuration) of the local client. Normalizing actions involves defining a unified format and set of conventions for how actions are performed, so that the API's interactions are predictable and uniform, which simplifies integration and improves usability for developers.

The shared extension-based framework is a modular and flexible framework designed to provide blended remote-local settings management by allowing the integration of individual settings controllers. Each controller is a distinct module that provides specific functionality and can be on-boarded to the blended remote-local settings management based on the framework's standards. The shared extension-based framework enables a core system to orchestrate and manage the various settings controllers that interact with it. Each setting controller may operates independently, offering unique features or services.

The on-boarding process for a new settings controller can involve registering it with the blended remote-local settings management engine and configuring it to meet the framework's interface standards. This ensures that the settings controller integrates smoothly and functions correctly within the overall system. Additionally, settings controllers can be independently updated to enhance their capabilities or fix issues, with the framework facilitating these updates while preserving system compatibility. Settings controllers can also be extended to include new features or modify existing ones. The shared extension-based framework supports these modifications, ensuring that new functionalities can be seamlessly incorporated into the platform. The use of a standard interface or protocol is pivotal in this framework. It defines how settings controllers communicate with the blended remote-local settings management engine, ensuring consistent and reliable interactions regardless of individual updates or extensions.

The blended remote-local settings management engine operates based on a shared extension-based framework that is backwards compatible, such that newer versions of operating systems on remote clients can operate with older versions of operations systems of local clients. And, the shared extension-based framework is also cross-platform compatible, such that, the functionality can be provided on multiple operating systems or devices without modification. To ensure backwards compatibility, the shared extension-based framework is designed to preserve existing endpoints, data formats, and behaviors, allowing older operating systems to function as expected even as updates are made. In addition, versioning allows the shared extension-based framework to support multiple versions simultaneously, ensuring continuity for users relying on older versions. Updates can be made in a backward-compatible manner, such as by adding optional fields or endpoints without altering existing functionality.

For cross-platform compatibility, a shared extension-based framework adheres to widely accepted standards and protocols to ensure broad accessibility and understanding across different technologies. The shared extension-based framework code is designed to be platform-agnostic, avoiding reliance on platform-specific features and using portable programming languages. Data formats used by the shared extension-based framework are universally readable and writable to support various platforms. Consistency in shared extension-based framework responses and functionality for different types of setting controllers is ensured across all platforms, and when necessary, platform-specific documentation or tools, such as SDKs or libraries, are provided to aid developers in integration.

The blended remote-local settings management engine employs key-store value commands and an interface designed to manage settings associated with different types of settings controllers by linking the setting controllers and/or each piece of information to a unique key. For example, the Get/Set/Value (key) function pattern is a versatile approach for handling key-value pairs in various software systems. This interface supports essential operations for data manipulation: including storage, retrieval, and updating. Storage allows users to add or update data by associating a value with a specific key. This ensures that each key is mapped to its corresponding value, which can be adjusted as necessary. Retrieval facilitates the retrieval of data by querying it with a key. It returns the value associated with the provided key, making it possible to access the stored information quickly. Updating permits the modification of existing data by specifying a key and a new value. This operation either updates the value for an existing key or adds a new key-value pair if the key is not already present. The key-store value interface streamlines data management by offering straightforward and efficient methods for storing, retrieving, and updating information based on unique identifiers.

The blended remote-local settings management engine includes blended remote-local settings management engine client that operates on the local client. The blended remote-local settings management engine client facilitates functionality of the blended remote-local settings management engine on the local client. The blended remote-local settings management engine client is integrated with a plurality of setting controllers to support executing requests from remote clients. The blended remote-local settings management engine client can contain a mapping of keys to settings controllers. Based on the keys, the blended remote-local settings management engine client routes requests to the appropriate settings controller.

The requests can be associated with different types of commands (e.g., GETSETTINGSVALUE, GETSETTINGSOPTIONS, GETSETTINGSMETADATA, and SETSETTINGSVALUE). Blended remote-local settings management data can include data associated with the different types of key-store value commands; the blended remote-local settings management data includes values retrieved from settings that are retrieved, settings options, settings metadata, and/or values to be set for settings. Blended remote-local settings management data is communicated through the dynamic virtual channel between local clients and remote clients. It is contemplated that local settings are not stored in the remote client; rather, the local settings are provided for real-time management via the dynamic virtual channel and blended remote-local settings interfaces.

The blended remote-local settings management engine provides blended remote-local settings management data via blended remote-local settings interfaces on remote clients. The blended remote-local settings interfaces refer to graphical user interfaces (GUI) that allows users to view, modify, and manage various system settings and configurations on their client. These blended remote-local settings interfaces provide access to a wide range of options, allowing users to customize their computing environment to suit their preferences and needs. The blended remote-local setting interface supports displaying remote settings alongside local settings that are retrieved from a local client. The blended remote-local setting interface can support showing remote settings and local settings alone or in combination with each other side-by-side. The blended remote-local setting interface can be a normalized GUI for different types of blended remote-local settings management data that provides a standardized and consistent user interface design that adapts to various data types while maintaining a unified look and feel. This approach ensures that regardless of the data being displayed—whether text, images, or numerical values—the interface elements, such as controls and layouts, follow a consistent format. The normalization of the GUI enhances usability by offering users a familiar interaction model, making it easier to understand and manage diverse types of data efficiently.

The blended remote-local settings management engine can support settings that synchronized (i.e., synchronized mode) or desynchronized (i.e., desynchronized mode) between a local client and a remote client. Synchronized settings refer to configurations that are updated and maintained across the local and remote clients to ensure uniformity and coherence. When settings are synchronized, any change made on a local client can be propagated to a remote client, maintaining consistency. Desynchronized settings, on the other hand, occur when configurations are not aligned across the local client and remote client, resulting in variations where changes made on the local client do not affect the remote client. It is contemplated synchronization and desynchronization of specific settings can be managed manually or automatically, such that they are selectively applied to different types of settings.

The blended remote-local settings management engine may support auto-applying settings at login. This means that specific configurations or preferences are automatically enforced when a user logs into a system without requiring manual intervention. This process ensures that the local settings are immediately applied and active upon entering the remote client. For example, individuals with visual impairments can select their preferred contrasting colors for better visibility. While the default setting might be black and white, users have the option to choose colors like green for highlights and other settings tailored to standard accessibility needs. This customization helps to enhance the readability and usability of the interface based on individual preferences. Auto-applying these local settings as the user logs in streamlines the configuration process and enhances user convenience and ensures a consistent environment from the moment they start their remote session.

### Example Systems and Resources

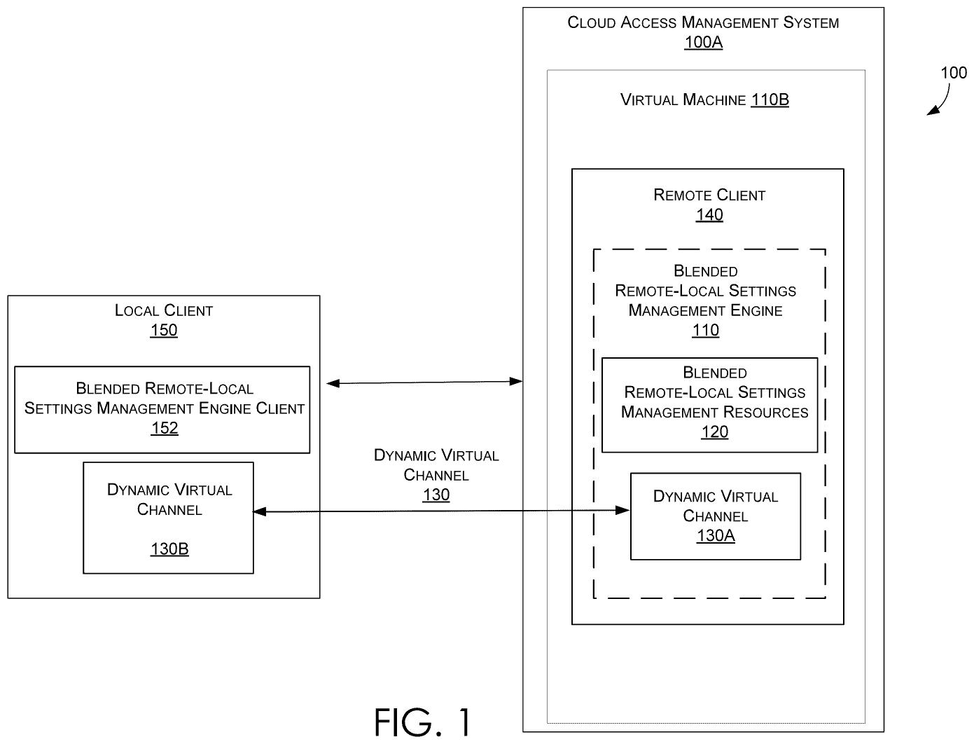

Aspects of the technical solution can be described by way of examples and with reference to FIGS. 1A-1C. FIG. 1A illustrates a cloud computing environment (system) 100, cloud access management system 100A, virtual machine 110B, blended remote-local settings management engine 110, blended remote-local settings management resources 120, dynamic virtual channel 130 (including dynamic virtual channel 130A and dynamic channel 130B) remote client 140, local client 150, and blended remote-local settings management engine client 152.

The cloud access management system 100A provides a centralized platform designed to facilitate secure and efficient access to cloud-based resources (e.g., remote clients). The connection service 112 provides a control plane (e.g., a virtual desktop control plane) that operates as a centralized management and administration infrastructure service that is responsible for managing user sessions, virtual machines, networking, authentication, and other aspects of a virtual desktop environment.

Virtual machine 110B is a representative virtual machine (VM) that is provisioned to serve as a session host for users accessing desktops and applications remotely. A VM can run an operating system (e.g., WINDOWS) and is configured with the necessary resources, such as CPU, memory, storage, and network connectivity, to support multiple concurrent user sessions. VMs are managed and maintained to ensure scalability, reliability, and performance for the desktop virtualization environment.

The blended remote-local settings management engine 110 provides blended settings management experiences on remote clients that mirror local settings management of local clients. The blended remote-local settings management engine 110 operates using a shared extension-based framework (e.g., custom settings handlers, custom settings view models, extension services, and a unified Application Programming Interface—API) for integrating different settings controllers into blended settings management via remote clients.

The blended settings management resources 120 can include operations, interfaces, and data components that support blended settings management functionality. Operations refer to the tasks necessary for configuring and maintaining hardware and software settings. For hardware settings, this includes configuring components like physical devices and peripherals. For software settings, operations configuring software settings to meet user preferences or operational needs.

Interfaces are the tools or methods used to interact with and manage these settings. For hardware settings, interfaces include Device Manager in Windows for managing hardware devices, updating drivers, and troubleshooting issues; and system information tools like Task Manager in Windows or lshw in Linux, which provide detailed hardware information. For software settings, interfaces consist of the Control Panel or Settings App in Windows for configuring a wide range of system and application settings; System Preferences in macOS for adjusting system-wide settings and application preferences.

Data represents the information and configurations managed during the setup and maintenance of hardware and software. For hardware settings, this includes physical device and peripheral configuration data. For software settings, data involves application configurations including preferences and settings files; system settings related to network configurations, security policies, and user profiles; and logs and diagnostics offering insights into software performance and issues.

A dynamic virtual channel (e.g., dynamic virtual channel 130A and dynamic virtual channel 130B collectively “dynamic virtual channel 130”) refers to a logical connection established between a remote client and a local client to support blended remote-local settings management. The dynamic virtual channel can provide a dedicated path or channel for transmitting blended remote-local settings management data between a remote client and a local client. The dynamic nature of the channel indicates that the establishment or allocation of the virtual channel does not have to be fixed or preconfigured. The dynamic virtual channel can be created and managed dynamically based on real-time needs and conditions of the blended settings management.

Local client 150 connects to a remote client 140 to access cloud-based resources. The local client 150 can include a blended remote-local settings management engine client 152 that enables blended settings management functionality on the local client 150. The local client 150 runs a remote desktop client that enables users to access and control a remote client 140. In this way, users can retain control over local settings of their local clients when utilizing remote clients (e.g., in boot-to-cloud scenarios)—enabling them to seamlessly configure different types of local hardware and software settings (e.g., display settings, audio settings).

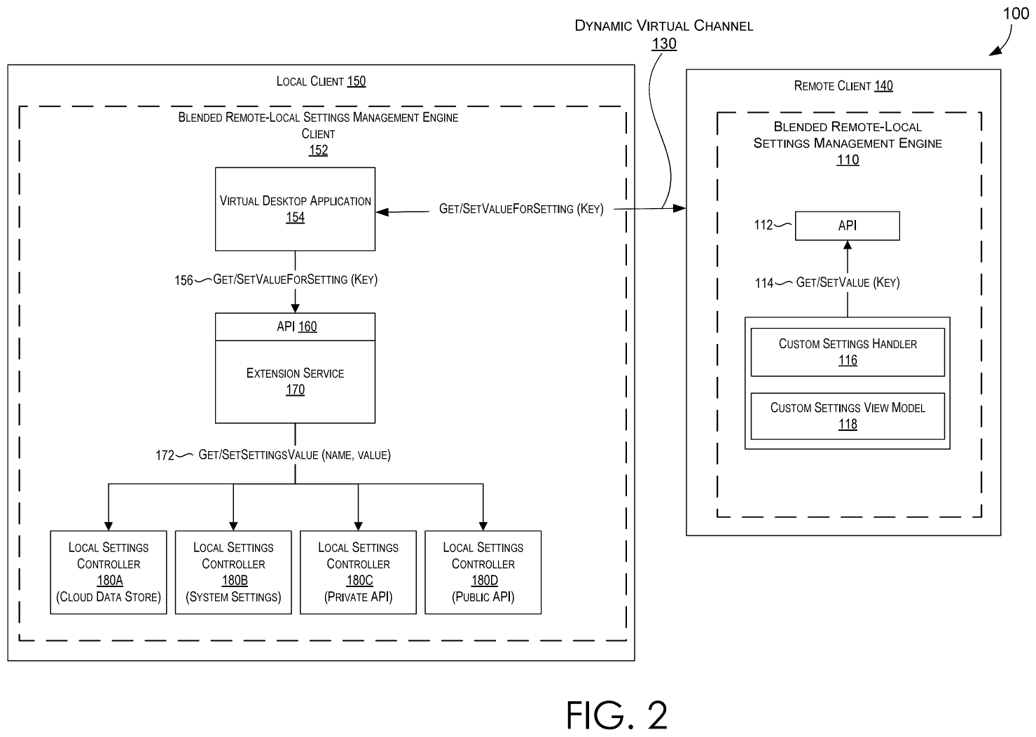

With reference to FIG. 2, FIG. 2 illustrates cloud computing environment 200, blended remote-local settings management engine 110, dynamic virtual channel 130, internal API 112, key-store value command 114, custom settings handler 116, custom settings view model 118, blended remote-local settings management engine 152, virtual desktop application 154, key-store value command 156, API 160, extension service 170, key-store value command 172, and a plurality of local settings controllers (i.e., settings controller 180A, settings controller 180B, settings controller 180C, and settings controller 180D).

By way of illustration, remote client 140 receives an indication to initiate settings configuration on the remote client 140. The indication is processed using a blended remote-local settings management engine 110 that integrates management of remote settings of remote clients and local settings of local clients. It is contemplated that the remote client 140 (e.g., via the blended remote-local settings management engine 110) determines that the indication is not associated with a settings controller that has been on-boarded for blended settings management, as such, blended settings management is not triggered. However, when the indication is associated with a settings controller that has been on-boarded for blended settings management, blended settings management is triggered.

Based on the indication, blended remote-local settings management engine 110 generates a request (e.g., a key-value store command) for a local setting of a local client associated with the remote client. The request for the local setting of the local client comprises a property logic for getting and setting local settings values. By way of illustration, the blended remote-local settings management engine 110 includes a shared extension-based framework including custom settings handler 116 and a custom settings view model 118. Custom settings handler 116 supports processing specific types of settings events. The custom settings handler 116 acts upon the data it receives, performing tasks like executing commands, modifying states, or responding to triggers.

The custom settings view model 118 manages data and behavior needed for user interfaces (UIs) associated with blended settings management. Custom settings view model 118 acts as an intermediary between the model (data) and the view (UI), providing a structured way to bind data and commands to the UI elements. The custom settings view model 118 ensures that the UI can react to data changes and user interactions in a clean and manageable way. The blended remote-local settings management engine 110 employs the shared extension-based framework to generate key-store value commands (e.g., key-store value command 114).

API 112 processes key-store value command 114 and communicates the key-store value command via dynamic virtual channel 130. The API manages data using key-value pairs and facilitates communication over virtual channels that can be dynamically created or managed. The API 112 facilities performing operations such as storing, retrieving, updating, key-value pairs associated with settings controllers on the local client 150. Each key maps to a settings controller, enabling efficient data management and retrieval.

Blended remote-local settings management engine client 110 communicates the request to the local client 150 using a dynamic virtual channel 130 between the remote client and local client. The dynamic virtual channel 130 supports communication of blended remote-local settings management data between the local client and the remote client. The dynamic virtual channel 130 can facilitate real-time, on-demand interactions or data exchanges (i.e., blended remote-local settings management data) between the remote client 140 and local client 150. The blended remote-local settings management data facilitates simulating local settings configuration interfaces of local clients via remote settings configuration interfaces on remote clients. Based on communicating the request, the blended remote-local settings management engine 140 retrieves the local setting of the local client 150 and causes display of the local setting on a blended remote-local settings interface.

Blended remote-local settings management engine client 152 provides a bridge via a local endpoint on the local client 150 to a plurality of setting controllers on the local client 150. The local client 150 is associated with a hardware settings corresponding to physical devices and peripherals connected to the local client 150, and software settings corresponding to a software environment and applications of the local client 150. The local client 150 and the remote client 140 can be associated with different platforms (e.g., Windows and Linux); and the local client 150 and the remote client 140 can be associated with different operating system versions (e.g., Windows 11 and Windows 10).

Local settings controllers (i.e., settings controller 180A, settings controller 180B, settings controller 180C, and settings controller 180D) can be associated with cloud data store settings, system settings, settings associated with private APIs, or settings associated with public APIs. The local client 150 can include a virtual desktop application 154 that provides access to the remote client 140. The virtual desktop application 154 can receive a key-store value command (e.g., key-store value command 156) from the remote client 140 to facilitate providing blended settings management functionality on the remote client 140.

By way of illustration, the local client 150 accesses a request (e.g., key-store value command 156) from remote client 140 for a local setting of the local client 150. The request is accessed via the dynamic virtual channel 130 between the remote client and local client. Using a blended remote-local settings management engine client 152, local client 150 retrieves a local setting from a settings controller. The blended remote-local settings management engine client 152 is integrated with a plurality of settings to corresponding setting controllers to support executing requests from remote clients for local settings of local clients. In particular, the plurality of settings controllers can be associated with keys, such that extension service 170 executes key-store value commands on specific settings controllers.

Retrieving the local setting and other types of blended remote-local setting management data includes: selecting a settings controller associated with the request; executing the request on the settings controller; and based on executing the request, retrieving blended remote-local settings management data comprising the local setting. In this way, the extension service 170 adds specific blended settings management functionality to the local client 150. Extension service 170 integrates with the local client 150 environment to enhance its capabilities or customize its behavior without altering the underlying system. Extension service 170 can be designed be modular and reusable, allowing different types of settings controllers to leverage its functionality. The extension service 170 can get and set settings values, and further retrieve different types of blended remote-local settings management data associated with different commands (e.g., GETSETTINGSVALUE, GETSETTINGSOPTIONS, GETSETTINGSMETADATA, and SETSETTINGSVALUE).

Local client 150 communicates blended remote-local settings management data including the local setting to the remote client; the blended remote-local settings management data is communicated via the dynamic virtual channel. The blended remote-local settings management data can also include selectable alternate local settings (i.e., settings options) of the local client. Remote client 140 receives the blended remote-local settings management data via the dynamic virtual channel 130. Remote client 140 causes display of the local setting and the one or more selectable alternative local settings of the local client on the blended remote-local settings interface. The remote client 140 can receive a selected alternative local setting from the one or more selectable alternative local settings and communicate a request to modify the local client based on the selected alternative local setting.

By way of illustration, a local setting can refer to the configuration specific to local client 150. For instance, when adjusting the display settings on the local client 150, the local setting may include the current screen resolution and color depth. An alternative local setting can refer to a different option that is selectable to modify the local setting. For example, if the local setting is a screen resolution of 1920×1080, an alternative local setting may be a resolution of 2560×1440. The alternative local setting is selectable to change how content is displayed on your monitor.

A blended remote-local settings interface of the blended remote-local setting engine 110 supports a plurality of display modes: a first display mode that causes display of remote settings only; a second display mode that causes display of local settings only; and a third display mode that causes display of both remote settings and local settings. In addition, the blended remote-local settings management engine 110 supports a synchronized mode and a desynchronized mode. Synchronized settings refer to configuration parameters that are updated and maintained across both local and remote clients to ensure consistency and coherence. When settings are synchronized, any modification applied on a local client is propagated to the remote client, ensuring that both systems remain uniform. Conversely, desynchronized settings occur when configuration parameters are not aligned between the local and remote clients. In this scenario, changes made on one client do not propagate to the other. The process of synchronization and desynchronization can be managed either manually or automatically. This allows for granular control over which settings are synchronized and which are not, enabling selective application to various types of settings based on operational requirements and preferences.

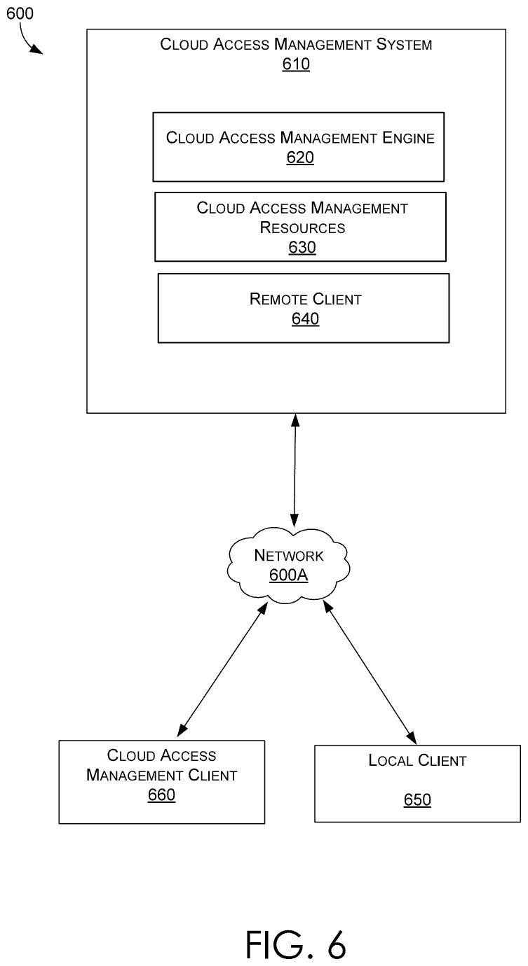

Aspects of the technical solution have been described by way of examples and with reference to FIGS. 1 and 2. FIG. 1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1 illustrates a high level architecture of the cloud computing system 100 in accordance with implementations of the present disclosure, among other engines, managers, generators, selectors, or components not shown (collectively referred to herein as “components”).

### Example Methods

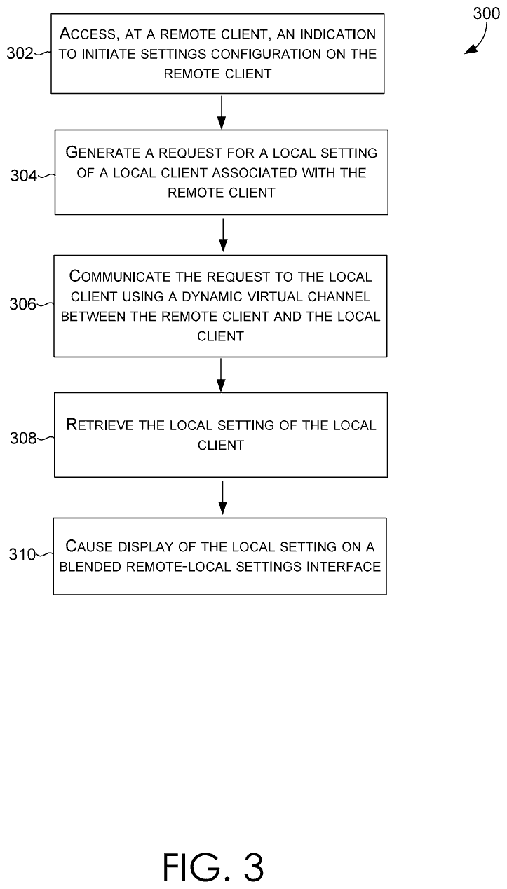

With reference to FIGS. 3, 4, and 5, flow diagrams are provided illustrating methods for providing blended settings management using a blended remote-local settings management engine in a cloud access management system. The methods may be performed using the cloud access management system described herein. In embodiments, one or more computer-storage media having computer-executable or computer-useable instructions embodied thereon that, when executed, by one or more processors can cause the one or more processors to perform the methods (e.g., computer-implemented method) in the cloud access management system (e.g., a computerized system).

Turning to FIG. 3, a flow diagram is provided that illustrates a method 300 for providing blended settings management using a blended remote-local settings management engine in a cloud access management system. At block 302, access, at a remote client, an indication to initiate settings configuration on the remote client. At block 304, generate a request for a local setting of a local client associated with the remote client. At block 306, communicate the request to the local client using a dynamic virtual channel between the remote client and the local client. At block 308, retrieve the local setting of the local client. At block 301, cause display of the local setting on a blended remote-local settings interface.

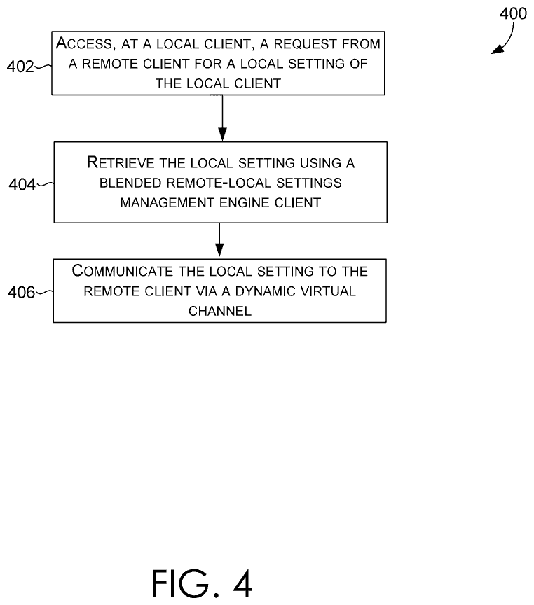

Turning to FIG. 4, a flow diagram is provided that illustrates a method 400 for providing blended settings management using a blended remote-local settings management engine in a cloud access management system. At block 402, access, at a local client, a request from a remote client for a local setting of the local client. At block 404, retrieve the local setting using a blended remote-local settings management engine client. At block 406, communicate the local setting to the remote client via a dynamic virtual channel.

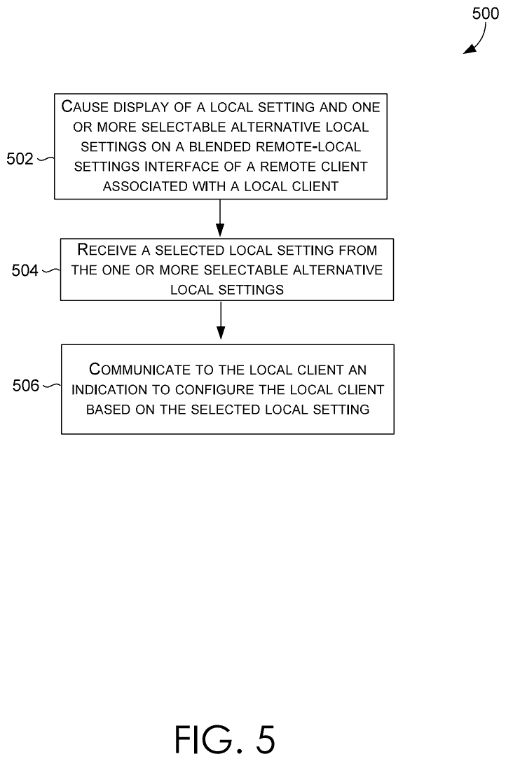

Turning to FIG. 5, a flow diagram is provided that illustrates a method 500 for providing blended settings management using a blended remote-local settings management engine in a cloud access management system. At block 502, cause display of a local setting and one or more selectable alternative local settings on a blended remote-local settings interface of a remote client associated with a local client. At block 504, receive a selected alternative local setting from the one or more selectable alternative local settings. At block 506, communicate a request to configure the local client based on the selected alternative local setting.

### Technical Improvement

Embodiments of the present techniques have been described with reference to several inventive features (e.g., operations, systems, engines, and components) associated with a cloud access management system. Inventive features described include: operations, interfaces, data structures, and arrangements of computing resources associated with providing the functionality described herein relative with reference to a blended remote-local settings management engine. Functionality of the embodiments of the present invention have further been described, by way of an implementation and anecdotal examples—to demonstrate that the operations for providing the blended remote-local settings management engine as a solution to a specific problem in device management technology to improve computing operations in cloud access management systems.

By way of example, the blended remote-local settings management engine supports providing blended settings management resources via a blended remote-local settings management engine that enables simulating local settings configuration interfaces of local clients via remote settings configuration interfaces on remote clients. Blended settings management is performed via a dynamic virtual channel between the remote clients and local clients, where the dynamic virtual channel supports communication of blended remote-local settings management data between the local clients and the remote clients. The blended remote-local settings management engine provides a solution that is and managing both remote settings and local settings provides via a unified interface that simplifies administration by allowing control over local hardware and software settings from a remote client, thus reducing the need for separate tools. This integration improves user experience by enabling seamless management of local settings like physical devices and peripherals and software environments and applications.

### Additional Support for Detailed Description

### Example Cloud Access Management in a Computing Environment

Referring now to FIG. 6, FIG. 6 illustrates a computing environment in which implementations of the present disclosure may be employed. In particular, FIG. 6 shows a high level architecture of an example cloud computing platform 600 and cloud access management system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing environment 100 provides computing system resources for different types of managed computing environments. For example, the cloud computing platform supports delivery of computing services-including compute, servers, storage, databases, networking, and intelligence. The components of cloud computing environment 600 may communicate with each other over a network 600A which may include, without limitation, one or more local area networks (LANs) and/or wide area networks (WANs).

The cloud access management system 610 provides cloud access management functionality for different types of cloud computing offerings. The cloud access management system can be a centralized platform designed to facilitate secure and efficient access to cloud-based resources from various devices, including traditional desktops, laptops, and thin clients. The cloud access management system can include software, hardware, and infrastructure components that enable users to authenticate, connect, and interact with remote resources hosted in the cloud. The cloud access management system manages operations associated with user identities, permissions, and access policies to ensure that only authorized users can access specific resources. Additionally, it may incorporate features such as single sign-on (SSO), multi-factor authentication (MFA), and session management to enhance security and user experience.

Cloud access management system 610 enables secure and efficient access for local clients to remote resources, such as remote clients, through a centralized platform. It encompasses authentication mechanisms to verify the identities of users and devices seeking access, including multi-factor authentication for enhanced security. Authorization protocols govern user permissions and access levels, dictating which resources or applications each user can utilize. Session management functionalities handle the establishment, monitoring, and termination of user sessions, optimizing performance while ensuring compliance with security policies. The cloud access management system also manages connections between local clients and remote clients, employing robust encryption and data integrity measures to protect sensitive information during transmission.

The cloud access management system 610 includes a cloud access management engine 620 that is a computing environment that supports executing computational tasks associated with the cloud access management system 610. The cloud access management engine 620 can be a hardware or software component that performs computational operations, such as, mathematical calculations, data processing, and algorithm execution. The cloud access management system 610 integrates cloud access management resources 630 into cloud access management system 610 to effectively provide cloud access management in a computing environment.

The cloud access management resources 630 refer to computing elements (e.g., components, capability, or entities) that collectively enable the cloud access management engine 620 operations. The cloud access management resources 630 encompass a spectrum of computing elements, beginning with the diverse operations the cloud access management resources 630 can perform, ranging from complex computations to data manipulations. Interfaces, an integral part of the cloud access management resources 630, provide the means for both user interaction and seamless integration with external systems, ensuring a dynamic and interactive computing experience. The data facet of the cloud access management resources 630 involves various types: input data, which is the information provided for processing; processing data, representing the data manipulated during computational tasks; and output data, the results generated by the cloud access management engine 620. In this way, the cloud access management resources 630 support the broader cloud access management engine 620 and cloud access management system 610.

The cloud access management resources can include speculation management resources (e.g., speculation management resources 112) that encompass the core operations, interfaces, and data components within cloud access management system 110, collectively supporting its functionality in overseeing diverse devices across the cloud computing system 100. Operations within the speculation management engine 110 speculative resource access, prefetching, speculation handling, machine learning, resource caching, and speculation timeout mechanisms. These operations are facilitated through interfaces such as speculation management, remote resource access, cache management, machine learning integration, and user interaction interfaces. Data components include speculation metadata, cached resource data, user interaction data, and speculation policies, which collectively inform speculation management decisions. Through these interconnected elements, the system aims to optimize resource utilization, reduce latency, and enhance user experience by intelligently anticipating and managing access to remote resources.

The cloud access management system 610 provisions remote clients (e.g., remote client 640). A remote client 640 can be virtual desktop environment (e.g., Desktop as a Service-DaaS). The remote client 640 leverages virtualization, cloud computing, and network technologies to deliver scalable, secure, and cost-effective virtual desktop environments to users, enabling flexible remote access to computing resources from any location, on any device. DaaS providers provide Virtualized Desktop Infrastructures (VDI) that host virtual desktops on servers in their data centers. These virtual desktops are created using virtualization technologies such as hypervisors or containerization platforms. Each virtual desktop includes an operating system, applications, data, and user settings.

The local client 650 connects to the remote client 640. The local client 650 can be a software application or device installed or used on the end-user's local hardware, such as a desktop computer, laptop, thin client, or mobile device. This client software facilitates the remote connection to the VDI hosted by the remote client provider, allowing end-users to access their virtual desktop environments over the internet. Local client 650 can be a managed client that is centrally controlled and monitored by cloud access management system 610. Managed clients typically have device management software installed or configured on them, allowing administrators to enforce security policies, configure settings, deploy applications, and perform remote management tasks. The local client 650 can be an unmanaged client that operates independently without being centrally controlled or monitored. These devices lack device management software or configurations, and users have full control over their settings and applications.

The cloud access management client 660 supports access to cloud access management system 610. Cloud access management client 660 provides a graphical or command-line interface for users or administrators to monitor and manage user sessions to ensure proper termination, timeout, and session activity logging. Configuring authentication methods such as passwords, multi-factor authentication (MFA), biometrics, or single sign-on (SSO) to verify user identities, and setting up authorization rules and permissions to govern user access to specific resources, applications, or data. The cloud access management client 660 supports centralized access management within a computing environment empowering efficient access administration.

### Example Distributed Computing System Environment

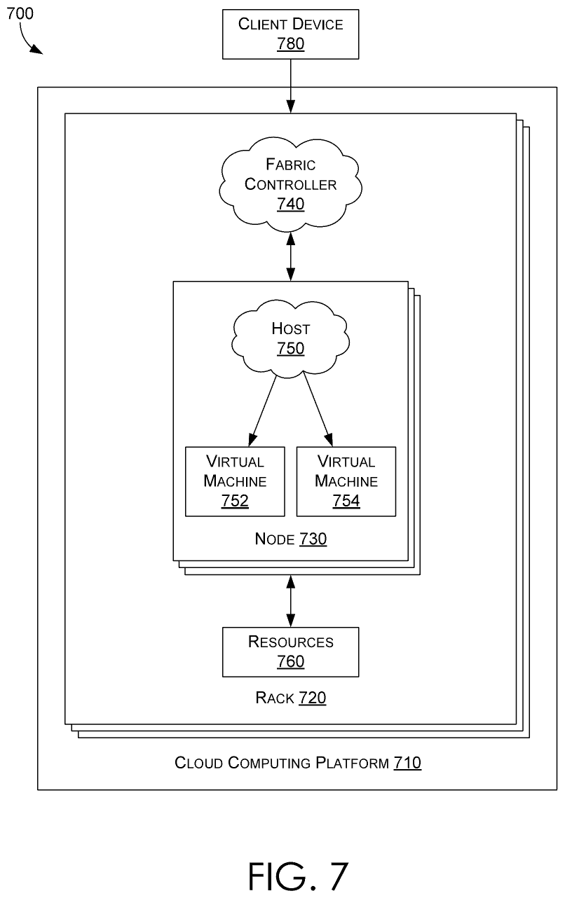

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

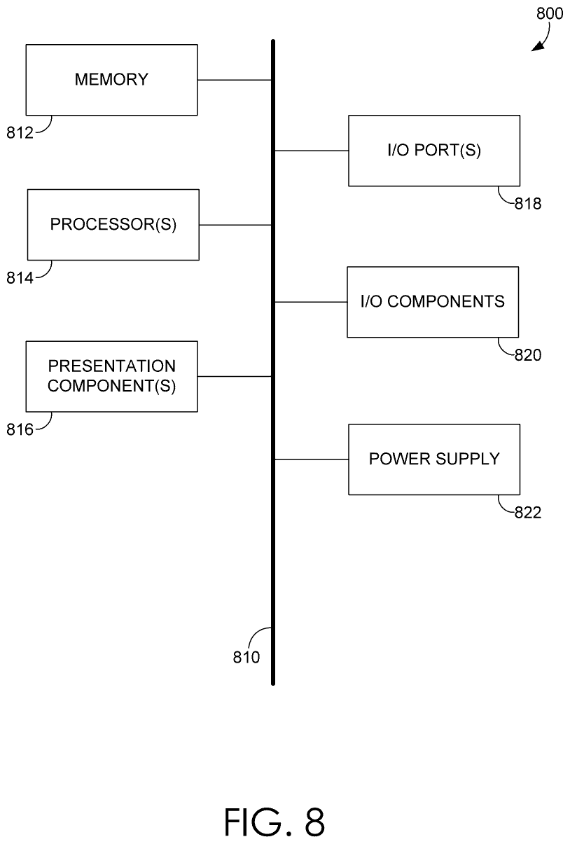

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing, at a remote client, an indication to initiate settings configuration on the remote client;
based on the indication, generating a request for a local setting of a local client associated with the remote client;
communicating the request to the local client using a dynamic virtual channel between the remote client and local client;
based on communicating the request, retrieving the local setting of the local client; and
causing display of the local setting on a blended remote-local settings interface.

2. The system of claim 1, wherein the indication is processed using a blended remote-local settings management engine comprising a shared extension-based framework including a custom settings handler and a custom settings view model associated with a plurality of settings controllers.

3. The system of claim 1, wherein the indication is processed using a blended remote-local settings management engine connecting to a local endpoint on the local client associated with a plurality of setting controllers on the local client.

4. The system of claim 1, wherein the request for the local setting of the local client comprises a property logic for getting and setting local settings values.

5. The system of claim 1, further comprising a blended remote-local settings management engine client configured to:
select a settings controller associated with the request;
execute the request on the settings controller;
based on executing the request, retrieve blended remote-local settings management data comprising the local setting; and
communicate the blended remote-local settings management data.

6. The system of claim 1, wherein the dynamic virtual channel supports communication of blended remote-local settings management data that facilitates simulating local settings configuration interfaces of local clients via remote settings configuration interfaces on remote clients, wherein the blended remote-local settings management data is retrieved from the local client based a plurality of key-store value commands.

7. The system of claim 1, wherein the dynamic virtual channel provides a dedicated path for pass-through settings data configuration in real-time between the local client to the remote client.

8. The system of claim 1, the operations further comprising:
causing display of the one or more selectable alternative local settings of the local client on the blended remote-local settings interface;
receiving a selected alternative local setting from the one or more selectable alternative local settings; and
communicating a request to configure the local clients based on the selected alternative local setting.

9. The system of claim 1, wherein the blended remote-local settings interface supports a plurality of display modes:
a first display mode that causes display of remote settings only;
a second display mode that causes display of local settings only; and
a third display mode that causes display of both remote settings and local settings.

10. The system of claim 1, wherein the indication is processed using a blended remote-local settings management engine that supports a synchronized mode and a desynchronized mode.

11. One or more computer-storage media having computer-executable instructions embodied thereon that, when executed by a computing system having a processor and memory, cause the processor to perform operations, the operations comprising:
accessing, at a local client, a request from a remote client for a local setting of the local client, wherein the request is accessed via a dynamic virtual channel between the remote client and local client;
using a blended remote-local settings management engine client, retrieving the local setting, wherein the blended remote-local settings management engine client is integrated with a plurality of setting controllers to support executing requests from remote clients for local settings of local clients; and
communicating the local setting to the remote client, the local setting is communicated via the dynamic virtual channel.

12. The media of claim 11, wherein the local client is operable in synchronized mode or desynchronized mode for blended settings management.

13. The media of claim 11, wherein the plurality of settings includes hardware settings corresponding to physical devices and peripheral connected to the local client, and software settings corresponding to a software environment and applications of the local client.

14. The media of claim 11, the operations further comprising:
selecting a settings controller associated with the request;
executing the request on the settings controller; and
based on executing the request, retrieving blended remote-local settings management data comprising the local setting.

15. The media of claim 11, wherein the plurality of settings controllers are mapped to corresponding keys, such that, key-store value commands are executable against the plurality of settings controllers based on the corresponding keys.

16. The media of claim 11, wherein the request comprises a key-value store command.

17. A computer-implemented method, the method comprising:
accessing, at a remote client, an indication to initiate settings configuration on the remote client;
based on the indication, generating a request for a local setting of a local client;
communicating the request to the local client using a dynamic virtual channel between the remote client and local client;
based on communicating the request, retrieving the local setting of the local client and one or more selectable alternative local settings;
causing display of the local setting and the one or more selectable alternative local settings on a blended remote-local settings interface;
receiving a selected alternative local setting from the one or more selectable alternative local settings; and
communicating, to the local client, a request to configure the local client based on the selected alternative local setting.

18. The method of claim 17, wherein the indication is processed using a blended remote-local settings management engine comprising a shared extension-based framework comprising a custom settings handler and a custom settings view model associated with a plurality of settings controllers.

19. The method of claim 17, wherein the dynamic virtual channel provides a dedicated path for pass-through settings data configuration in real-time between the local client to the remote client.

20. The method of claim 17, wherein the dynamic virtual channel supports communication of blended remote-local settings management data between the local client and the remote client, wherein the blended remote-local settings management data facilitates simulating local settings configuration interfaces of local clients via remote settings configuration interfaces on remote clients, and wherein the blended remote-local settings management data is retrieved from the local client based a plurality of key-store value commands.
